(19) United States
(12) Patent Application Publication
(10) Pub. No.: US 2015/0019243 A1
(43) Pub. Date: Jan. 15, 2015

(54) MEDICAMENT REGISTRATION APPARATUS AND METHOD FOR REGISTERING MEDICAMENT BY THE SAME

(71) Applicant: TOSHIBA TEC KABUSHIKI KAISHA, Tokyo (JP)

(72) Inventors: Toshihide Murata, Izunokuni-shi (JP); Hirokazu Watanabe, Tokyo-to (JP); Shiomi Matsui, Izunokuni-shi (JP); Makoto Nozawa, Shizuoka-ken (JP); Yoshiaki Kumai, Mishima-shi (JP); Maki Sato, Yokohama-shi (JP); Yumiko Okuma, Tokyo-to (JP); Shunichiro Kamamoto, Izunokuni-shi (JP); Ryu Morita, Mishima-shi (JP); Yasuhiro Nakajima, Izunokuni-shi (JP)

(21) Appl. No.: 14/326,670

(22) Filed: Jul. 9, 2014

(30) Foreign Application Priority Data
Jul. 10, 2013 (JP) 2013-144847

(51) Int. Cl. G06F 19/00

(52) U.S. Cl. CPC G06F 19/327
USPC 705/2

(57) ABSTRACT

In accordance with an embodiment, a medicament registration apparatus comprises a storage section, a recognition module and an output control module. The storage section stores a first medicament master in which first medicament information relating to each medicament is held and a second medicament master in which second medicament information including determined output form of each medicament is held. The recognition module recognizes a medicament of a reading target. The output control module outputs the first medicament information corresponding to the medicament recognized by the recognition module according to the determined output form in the second medicament information.

### CROSS-REFERENCE TO RELATED APPLICATION

This application is based upon and claims the benefit of priority from Japanese Patent Application No. 2013-144847, filed Jul. 10, 2013, the entire contents of which are incorporated herein by reference.

### FIELD

Embodiments described herein relate to a medicament registration apparatus and a medicament registration method.

### BACKGROUND

Several systems have been proposed to prevent occurrence of errors such as taking an incorrect medicament by mistake and the like. For example, medicament information specified by the barcode attached to the container of a medicament that is actually prescribed is compared with information of a medicament that is originally prescribed to prevent use of the incorrect medicament.

In an operating room, a nurse collects empty containers of medicaments used or consumed in a surgery after the surgery is performed, and manually records the result of the collection on the used medicaments on a slip to transmit the slip to a pharmaceutical department.

However, it occurs frequently that some unexpected medicaments are used during a surgery or some medicaments are suddenly needed, for example, in an emergency room and the like, and the record and collection on the used medicaments is not necessarily conducted accurately and indeed within a given time. Further, even if an apparatus is introduced, there is also a barrier due to the difference from the manually-written slip that is actually practiced.

### BRIEF DESCRIPTION OF THE DRAWINGS

FIG. 1 is a block diagram illustrating the schematic configuration of a medicament management system according to an embodiment;

FIG. 2 is a front view illustrating the appearance of a medicament registration apparatus;

FIG. 3 is a block diagram illustrating the hardware constitution of the medicament registration apparatus;

FIG. 4 is a diagram illustrating an example of the data format of an in-hospital medicament master;

FIG. 5 is a block diagram illustrating the functional components of the medicament registration apparatus;

FIG. 6 is a front view of a used medicament slip on which medicament information is printed;

FIG. 7 is a flowchart illustrating the flow of a used medicament registration processing executed by the MPU of the medicament registration apparatus according to a control program;

FIG. 8 is diagram illustrating an example of a login screen;

FIG. 9 is a diagram illustrating an example of a patient registration screen;

FIG. 10 is a diagram illustrating an example of a medicament registration starting screen;

FIG. 11 is a diagram illustrating an example of a manual input screen; and

FIG. 12 is a diagram illustrating an example of a medicament registration screen.

### DETAILED DESCRIPTION

In accordance with one embodiment, a medicament registration apparatus comprises a storage section, a recognition module and an output control module. The storage section stores a first medicament master in which first medicament information relating to each medicament is held and a second medicament master in which second medicament information including determined output form of each medicament is held. The recognition module recognizes a medicament of a reading target. The output control module outputs the first medicament information corresponding to the medicament recognized by the recognition module in accordance with the determined output form in the second medicament information.

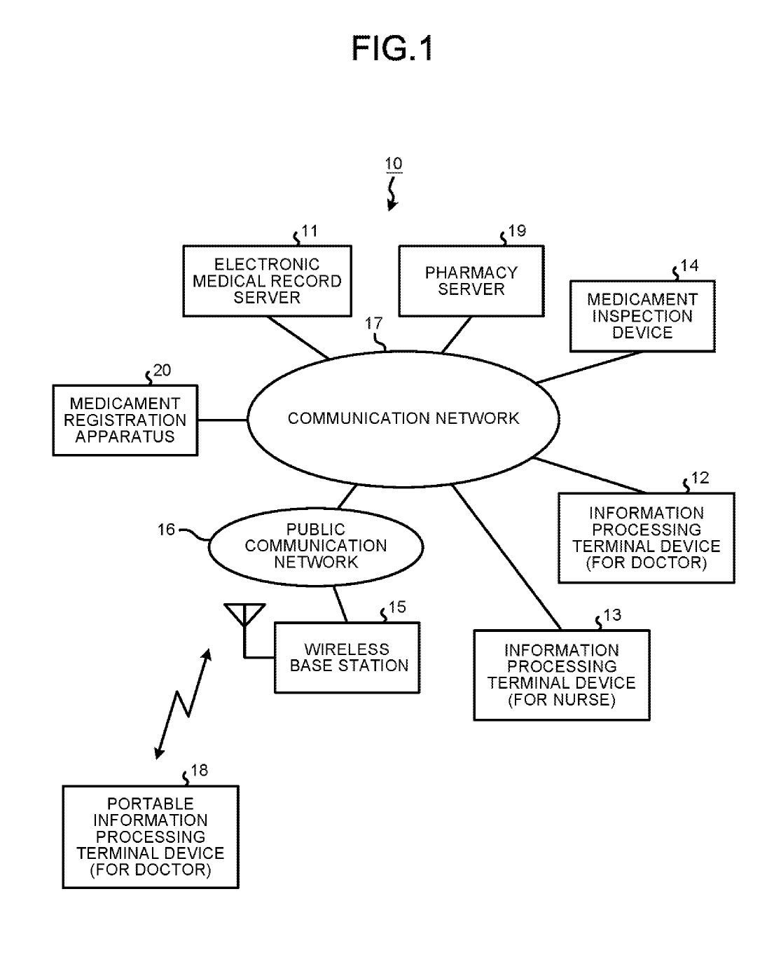

FIG. 1 is a block diagram illustrating the schematic configuration of a medicament management system 10 according to an embodiment. As shown in FIG. 1, the medicament management system 10 comprises an electronic medical record server 11, an information processing terminal device 12 for doctor, an information processing terminal device 13 for nurse, a medicament inspection device 14, a portable information processing terminal device 18 for doctor connected with a communication network 17 via a wireless base station 15 and a public communication network 16, a pharmacy server 19 and a medicament registration apparatus 20.

The electronic medical record server 11 stores electronic medical records and manages them. The information processing terminal device 12 for doctor is used to produce an electronic medical record. The information processing terminal device 13 for nurse is used for the reference to and the confirmation of the electronic medical record managed by the electronic medical record server 11. The medicament inspection device 14 is used for supporting and inspecting the preparation of a medicament and the like based on the instruction information (e.g. prescription information) contained in the electronic medical record. The pharmacy server 19 is arranged in a pharmacy to manage a medicament dispensing. Further, the pharmacy server 19 registers medicament information (name, quantity and the like) relating to a medicament in association with the code information of the medicament or the external surface information (the feature amount indicating the label of the medicament or the feature amount indicating the surface states of the medicament, such as a surface hue, concave-convex state and the like) of the medicament. The medicament registration apparatus 20 is arranged in an operating room for supporting a nurse to register the medicaments used in a surgery or the medicaments emergently used by a nurse or pharmacist in an emergency. In the present embodiment, the medicament registration apparatus 20 is arranged in an operating room to be used by a nurse to register the medicaments used in a surgery.

In the configuration above, the electronic medical record server 11, the information processing terminal device 12, the information processing terminal device 13, the medicament inspection device 14, the pharmacy server 19 and the medicament registration apparatus 20 are connected with the communication network 17.

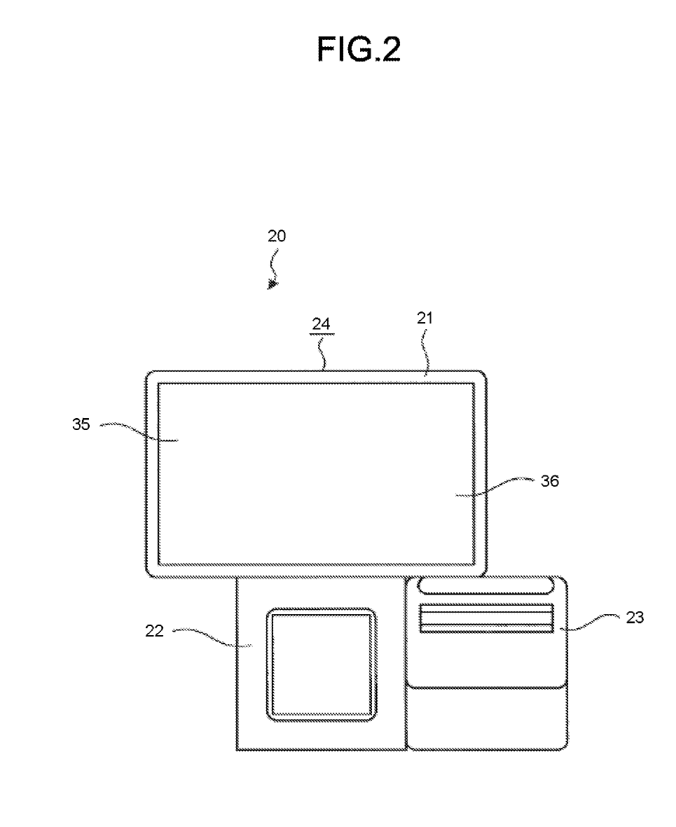

FIG. 2 is a front view illustrating the appearance of the medicament registration apparatus 20. As shown in FIG. 2, the medicament registration apparatus 20 roughly comprises an apparatus main body section 24 serving as the control main body of the medicament registration apparatus 20, a scanner 22 and a printer 23 for printing various kinds of information.

The apparatus main body section 24 comprises a touch panel display 21 for operator, that is, a nurse, to carry out various operations and for the display of various kinds of information including a list of the used medicaments and the like.

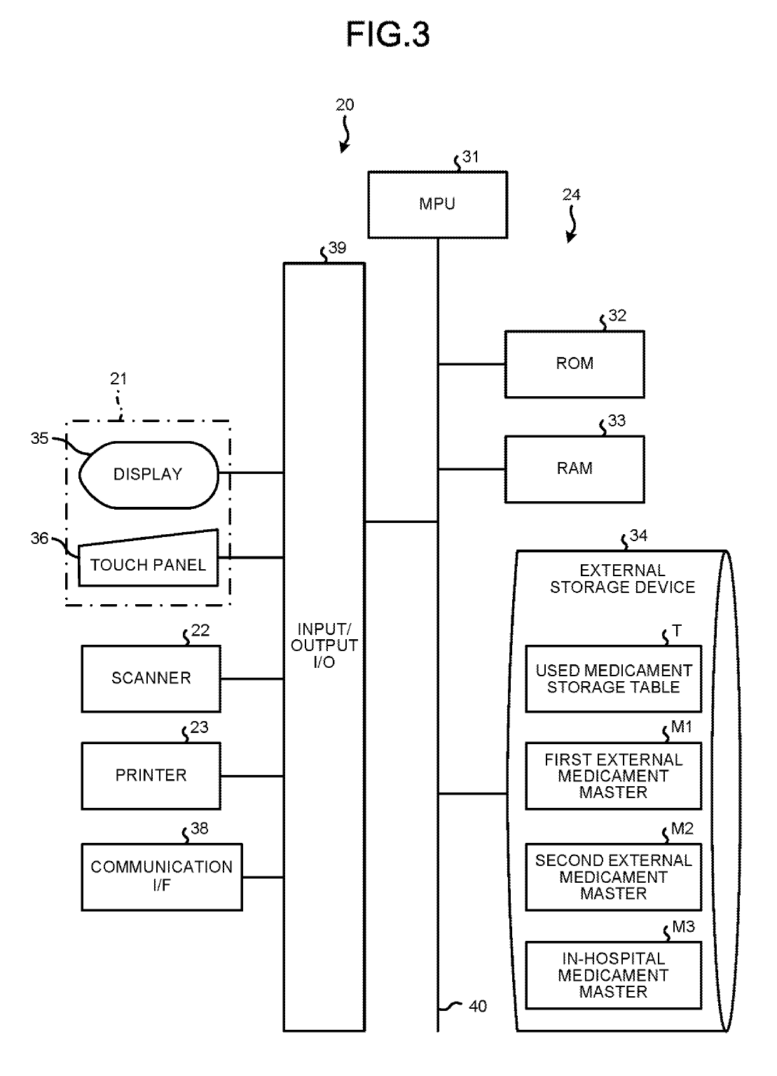

The scanner 22 comprises an image sensor such as a color CCD (Charged Coupled Device) image sensor or a color CMOS (Complementary Metal-oxide Semiconductor) image sensor and a light source such as an LED (Light Emitting Diode). The scanner 22 photographs the code symbol of a nurse ID (Identification), the code symbol of a patient ID, the code symbol of a medicament, a medicament and the like to capture images thoseof. The frame images (captured images) sequentially captured by the scanner 22 at a given frame rate are stored in the RAM (Random Access Memory) 33 described below (refer to FIG. 3).

The scanner 22 is not limited to be placed on the table shown in FIG. 2 but may vertically stand on the ground.

The medicament registration apparatus 20 may further comprise a scale for weighing a medicament and an RFID reader/writer for reading or writing data from or into the RFID (Radio Frequency Identification) attached to a medicament.

FIG. 3 is a block diagram illustrating the hardware constitution of the medicament registration apparatus 20. As shown in FIG. 3, an MPU (Micro Processor Unit) 31 for controlling the whole medicament registration apparatus 20, a ROM (Read Only Memory) 32, a RAM 33, an external storage device 34 and a communication interface (I/F) 38 for carrying out a communication interface operation are arranged in the apparatus main body section 24 of the medicament registration apparatus 20. The ROM 32 stores various kinds of data, including control programs, in a non-volatile manner. The RAM 33 functions as a working area to store various kinds of data temporarily. The external storage device 34 consists of a hard disk drive or SSD (Solid State Drive) capable of storing large-capacity data and control programs (such as a database and the like).

The touch panel display 21, the scanner 22, the printer 23 and the communication interface 38 are connected with a bus line 40 via an input/output I/O 39. The bus line 40 is connected with the MPU 31, the ROM 32, the RAM 33 and the external storage device 34.

The touch panel display 21 consists mainly of a display 35 serving as a display section and a touch panel 36.

The external storage device 34 serving as a storage section includes a used medicament storage table T. Further, the external storage device 34 includes a first external medicament master M1, a second external medicament master M2 and an in-hospital medicament master M3 as medicament masters. The result of collecting or counting the medicaments used is stored in the used medicament storage table T. The first external medicament master M1 and the second external medicament master M2 are medicament databases publicly opened by an external institution where medicament information is owned. Moreover, the first external medicament master M1 and the second external medicament, master M2 store code information in association with an official drug name.

The in-hospital medicament master M3 stores medicament information including the determined output form or manner of the medicament information stored in the first external medicament master M1 and the second external medicament master M2. The information of the determined output form or manner of medicament information refers to, for example, the print mode and the display mode of a slip used only in a hospital and the like. More specifically, for example, the information of the determined output form of medicament information is the classification name of a medicament, the print mode of the medicaments of each classification, an order according to which a medicament is recorded and a common name for medicaments.

Besides, there may be one or more than three external medicament masters. By storing medicament information in the external storage device 34 connected with the bus line 40, the medicament registration apparatus 20 according to the present embodiment can be used even in an environment in which network is not arranged.

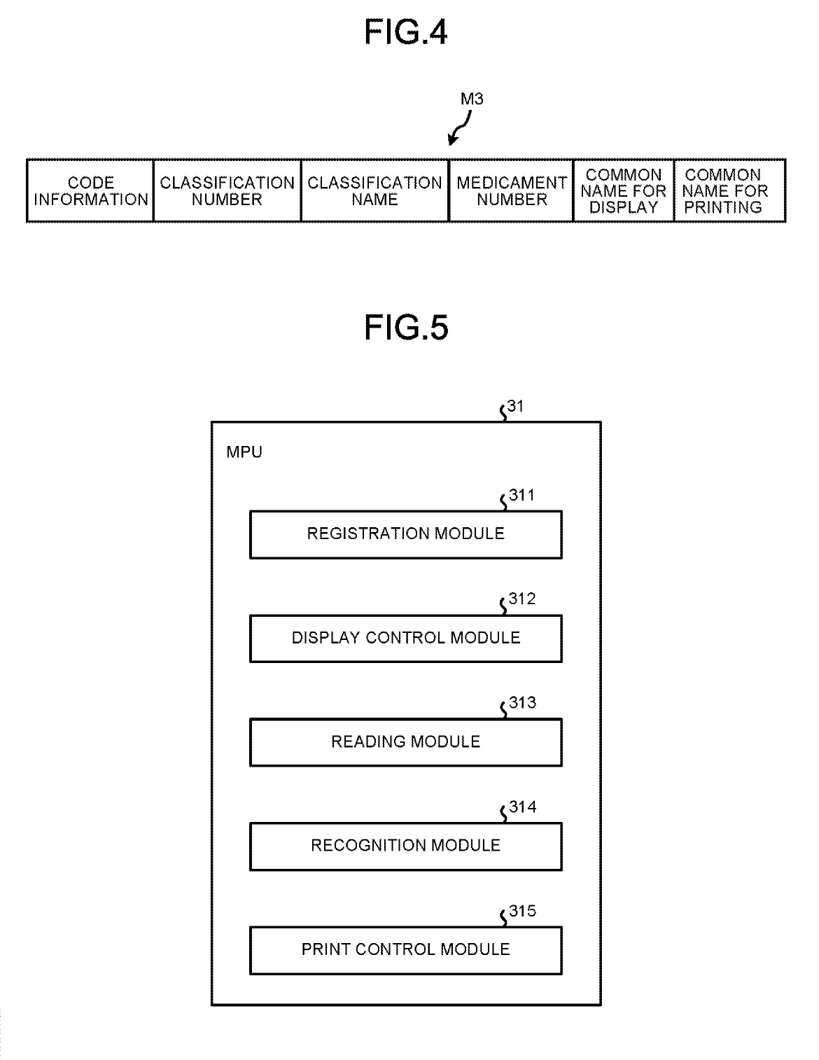

FIG. 4 is an illustration view illustrating an example of the data format of the in-hospital medicament master M3. As shown in FIG. 4, the in-hospital medicament master M3 stores code information, a classification number, a classification name, a medicament number, a common name for display and a common name for printing which are in association with one another. The code information is an identifier for identifying a medicament and thus is a number contained in a barcode, for example. Alternatively, the code information, for example, may be the external surface information and the like of a medicament.

The classification number which is a unique number for each classification of medicaments is printed on a slip and the like according to the order of a classification number. The classification name is identical with the name of a classification of medicaments. For example, the classification name is ‘common-used medicament ’, ‘medicament for ablation treatment’, ‘powerful medicament’ or ‘anesthetic’ and the like. The medicament number which is a unique number for each medicament is printed on a slip and the like according to the order of a medicament number. The common name for display, which is usually used in a hospital, is used when it is displayed on the display 35. The common name for printing, which is commonly used in a hospital, is used for printing the medicaments on a slip and the like. The display area of the display 35 is usually different in size from a slip printing area. Thus, with the use of the common name for display and the common name for printing, it is possible to improve the recognition in the present embodiment. Further, the common name for display and the common name for printing may also be a unified common name.

The data format of the in-hospital medicament master M3 may consist of only code information and a part of the aforementioned information. For example, the data format of the in-hospital medicament master M3 consists of code information and the classification name, code information, the common name for display and the common name for printing, or code information and the medicament number.

Further, the data format of the in-hospital medicament master M3 may also be added with new information. For example, the data format of the in-hospital medicament master M3 is added with information, such as a medicament price, a medicament manufacturer, warnings such as contraindication and side effect, and the image of the external surface of a medicament.

With such a structure, the MPU 31 of the medicament registration apparatus 20 operates according to the control programs stored in the ROM 32 and the external storage device 34 to carry out the support for the registration of the used medicament.

Next, the characteristic functions of the medicament registration apparatus 20 according to the present embodiment are described. FIG. 5 is a block diagram illustrating the functional components of the medicament registration apparatus 20. The MPU 31 operates according to the control programs stored in the ROM 32 and the external storage device 34 to function as a registration module 311, a display control module 312, a reading module 313, a recognition module 314 and a print control module 315, as shown in FIG. 5.

The reading module 313 reads the identifier of a medicament from the image of a medicament captured by the scanner 22. Specifically, the reading module 313 reads the code information of the code symbol attached to a medicament or all or part of the external surface information of the medicament used. The detection processing of code information from a code symbol such as a barcode or a two-dimensional code can be carried out with the conventional technologies and is therefore not described here.

The recognition module 314 recognizes the medicament based on the information (code information or external surface information) obtained from a reading result by the reading module 313 to extract medicament information. Specifically, the recognition module 314 recognizes the medicament by retrieving, from the medicament masters, code information which is the same as that read by the reading module 313. The recognition module 314 first retrieves the in-hospital medicament master M3. If the code information which is the same as that read by the reading module 313 is not contained in the in-hospital medicament master M3, the recognition module 314 retrieves the first external medicament master M1. If the code information which is the same as that read by the reading module 313 is not also contained in the first external medicament master M1, the recognition module 314 retrieves the second external medicament master M2.

In a manner of recognizing a medicament based on the external surface information of the medicament, the external surface information of the medicament is pre-stored in the form of a table corresponding to code information, and then the medicament can be recognized only by extracting the medicament information of the medicament based on the external surface information from the table.

The registration module 311 registers the medicament recognized by the recognition module 314 in the used medicament storage table T of the external storage device 34.

The display control module 312 serving as an output control module controls the display of the medicament information recognized by the recognition module 314 on the display 35 serving as a display section. If medicament information is detected by the recognition module 314 from the in-hospital medicament master M3, the display control module 312 displays the detected medicament information using the common name for display stored in the in-hospital medicament master M3. If no medicament information is detected by the recognition module 314 from the in-hospital medicament master M3, the display control module 312 displays medicament information using the official medicament name stored in the first external medicament master M1 or stored in the second external medicament master M2.

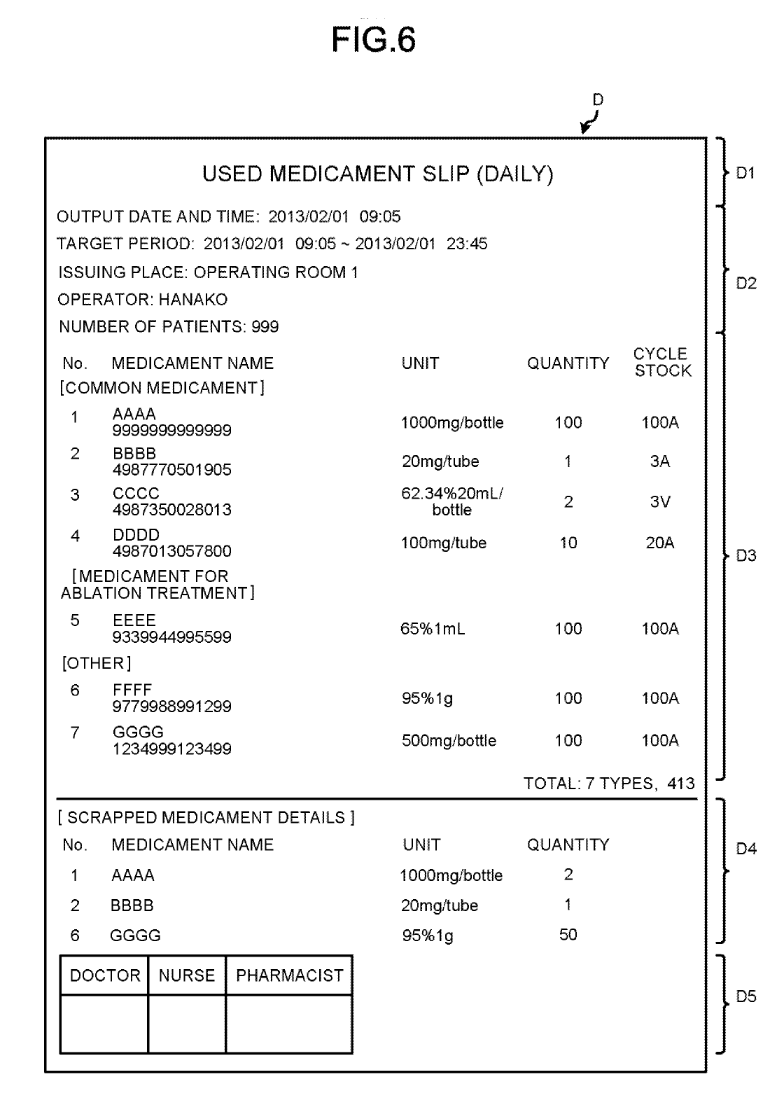

The print control module 315 serving as also an output control module controls the printer 23 serving as a printing section to print the medicament information recognized by the recognition module 314. If medicament information is detected by the recognition module 314 from the in-hospital medicament master M3, the print control module 315 prints the medicament information using the common name for printing stored in the in-hospital medicament master M3. If no medicament information is detected by the recognition module 314 from the in-hospital medicament master M3, the print control module 315 prints the medicament information using the official medicament name stored in the first external medicament master M1 or stored in the second external medicament master M2. FIG. 6 is a front view of a used medicament slip D on which medicament information is printed.

As shown in FIG. 6, a used medicament slip D includes areas of D1 for ‘header’, D2 for ‘basic information’, D3 for ‘used medicament data’, D4 for ‘scrapped medicament data’, and D5 for ‘approval seal column’. The D1 for ‘header’ is an area for printing a slip name. The D2 for ‘basic information’ is an area for printing an output date and time, a target period, an issuing place, an operator and the number of patients.

Columns ‘No.’, ‘medicament name’, ‘unit’, ‘quantity’ and ‘cycle stock’ are printed in the area of D3 for ‘used medicament data’. A classification name and an item ‘No.’ are printed in the column ‘No.’. The classification name is the name of a classification of medicaments. If the target medicament is contained in the in-hospital medicament master M3, the target medicament is printed in the column in the in-hospital medicament master M3 where the classification name thereof is recorded. Further, the classification name is printed in the order of a classification number. On the other hand, if the target medicament is not contained in the in-hospital medicament master M3, the target medicament is printed in the registration order thereof in ‘OTHER’ column where the classification name thereof is recorded. The item ‘No.’ which refers to a series of numbers assigned to each classification of medicaments is given continuously even in the case of different classification names.

A medicament name, the name of a medicament master and the code number of a medicament are printed in the column ‘medicament name’. If a target medicament is contained in the in-hospital medicament master M3, the medicament names are printed in the order of a medicament number in the form of the common names for printing in the in-hospital medicament master M3, thereby improving the discrimination of a medicament name. Further, information having a proper number of characters is printed as the medicament name, thus utilizing a printing area effectively. The name of the medicament master having the printed medicament information is printed in the name of a medicament master so that the operator can determine whether or not the name of the medicament is used only in the hospital. The code number of a medicament refers to a number contained in the code symbol of the medicament.

Further, as a manner of recognizing the name of a medicament master, a dedicated column may be set to print the name of a medicament master. Alternatively, a mark and the like may be added to recognize the name of a medicament master. The name of a medicament master may also be recognized by being displayed with a color different from others.

As shown in FIG. 6, the column ‘unit’ represents a standard for the dosage of a target medicament. The column ‘quantity’ represents the quantity of the used or consumed target medicament. The column ‘cycle stock’ represents the cycle stock of the target medicament. In this way, a pharmacy section performs the replenishing of medicaments used. The area D4 for the scrapped medicament data is used to print information of scrapped medicaments. The area D5 for the approval seal column D5 is used to print columns in which approval seals are stamped.

Next, a used medicament registration processing is described which is executed according to a control program by the MPU 31 of the medicament registration apparatus 20 according to embodiments described above. The medicament registration apparatus 20 according to the embodiment scans the code symbol of a used medicament and the image of a medicament to execute a medicament registration processing.

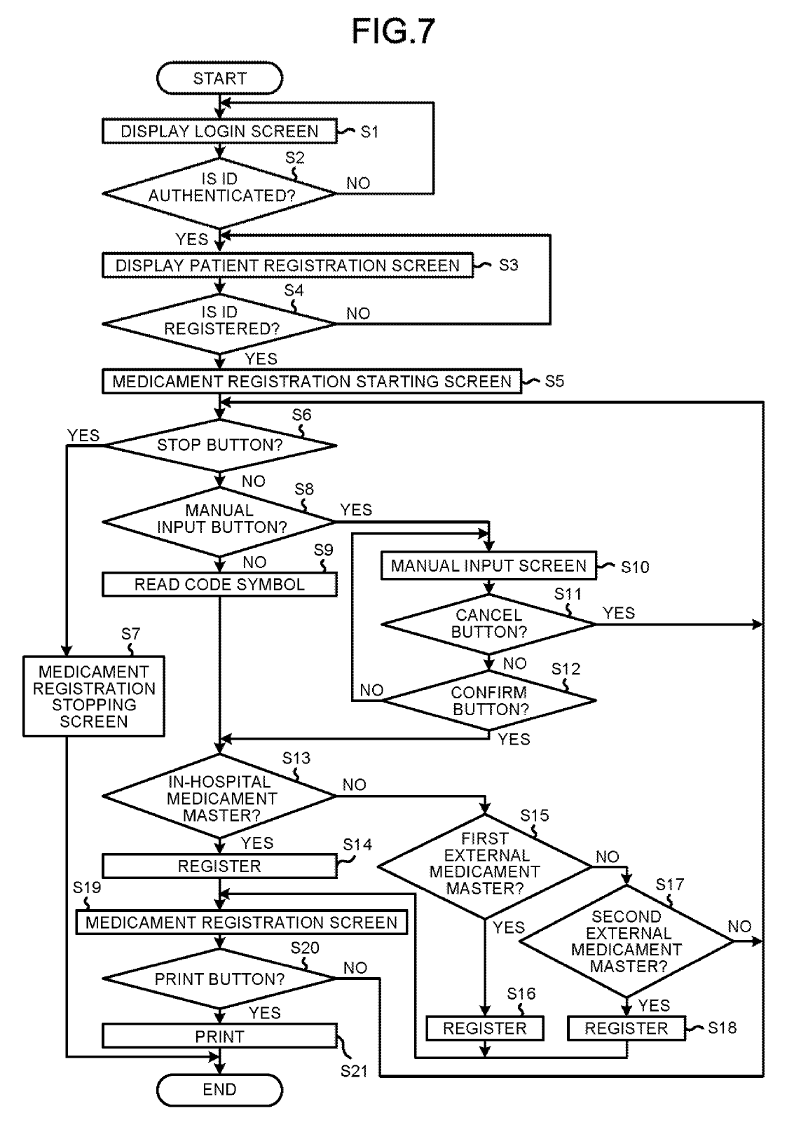

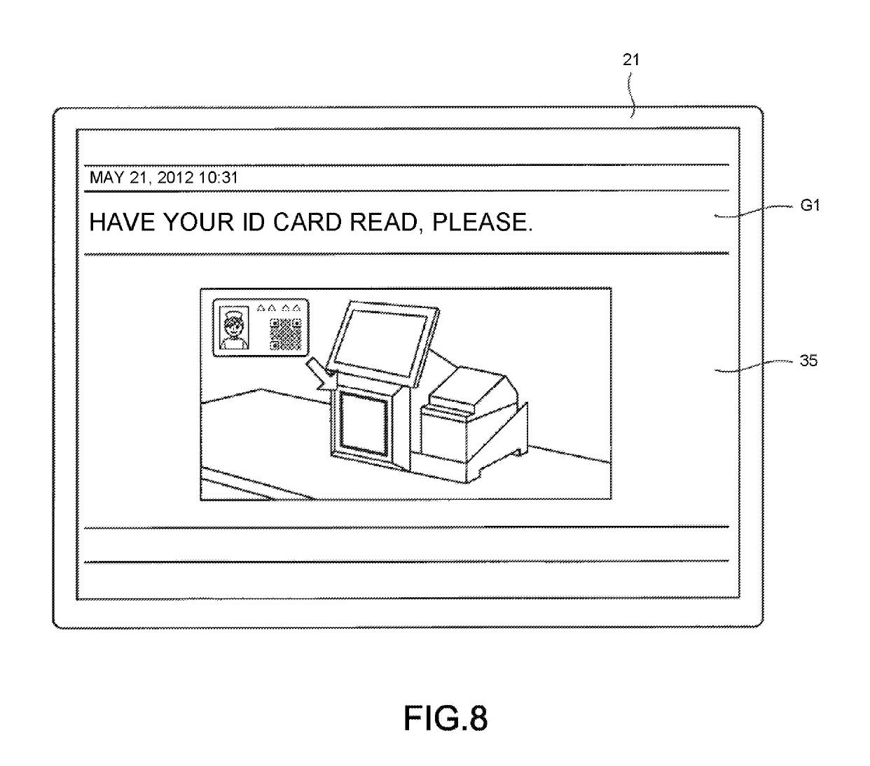

FIG. 7 is a flowchart illustrating the flow of the used medicament registration processing executed by the MPU 31 of the medicament registration apparatus 20 according to a control program. The MPU 31 of the medicament registration apparatus 20 displays, as shown in FIG. 8, a login screen on the display 35 as an initial state (ACT S1). Each operator (nurse) permitted to operate the medicament registration apparatus 20 has an ID card and thus the operator is able to operate the medicament registration apparatus 20 if the ID card carried by the operator is authenticated.

FIG. 8 is a diagram illustrating an example of a login screen G1. A guide comment of ‘Have your ID card read, please’ is displayed on the login screen G1, as shown in FIG. 8. Further, a card image is displayed on the login screen G1 to urge an operator (nurse) to hold his or her ID card to the scanner 22 to read the code symbol of the nurse ID printed on the ID card.

Thus, to carry out a login processing, the operator (nurse) holds the ID card in front of the scanner 22 to read the code symbol of the nurse ID of the ID card.

If the MPU 31 of the medicament registration apparatus 20 authenticates the nurse ID through a login processing (YES in ACT S2), a patient registration screen is displayed on the display 35 (ACT S3). On the other hand, if the nurse ID is not authenticated (NO in ACT S2), the MPU 31 of the medicament registration apparatus 20 takes ACT S1 to display the login screen G1 again.

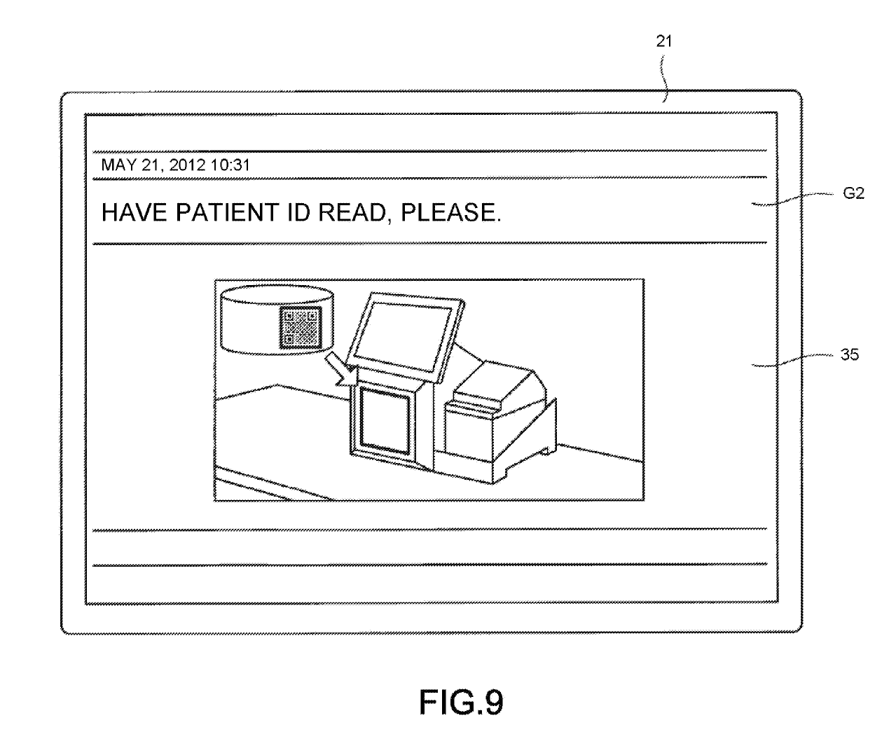

FIG. 9 is a diagram illustrating an example of a patient registration screen G2. A guide comment of ‘Have a patient ID read, please’ is displayed on the patient registration screen G2, as shown in FIG. 9. Further, a guide image is displayed on the patient registration screen G2 to urge the operator to read the code symbol of the patient ID attached to the wrist band of a patient with the scanner 22.

Thus, to carry out a patient registration processing, the operator (nurse) holds the wrist band of a patient in front of the scanner 22 to read the code symbol of the patient ID with the scanner 22.

If the MPU 31 of the medicament registration apparatus 20 registers the patient ID through a patient registration processing (YES in ACT S4), a medicament registration starting screen G3 is displayed on the display 35. On the other hand, if the patient ID is not registered (NO in ACT S4), the MPU 31 of the medicament registration apparatus 20 executes ACT S3 to display the patient registration screen G2 again.

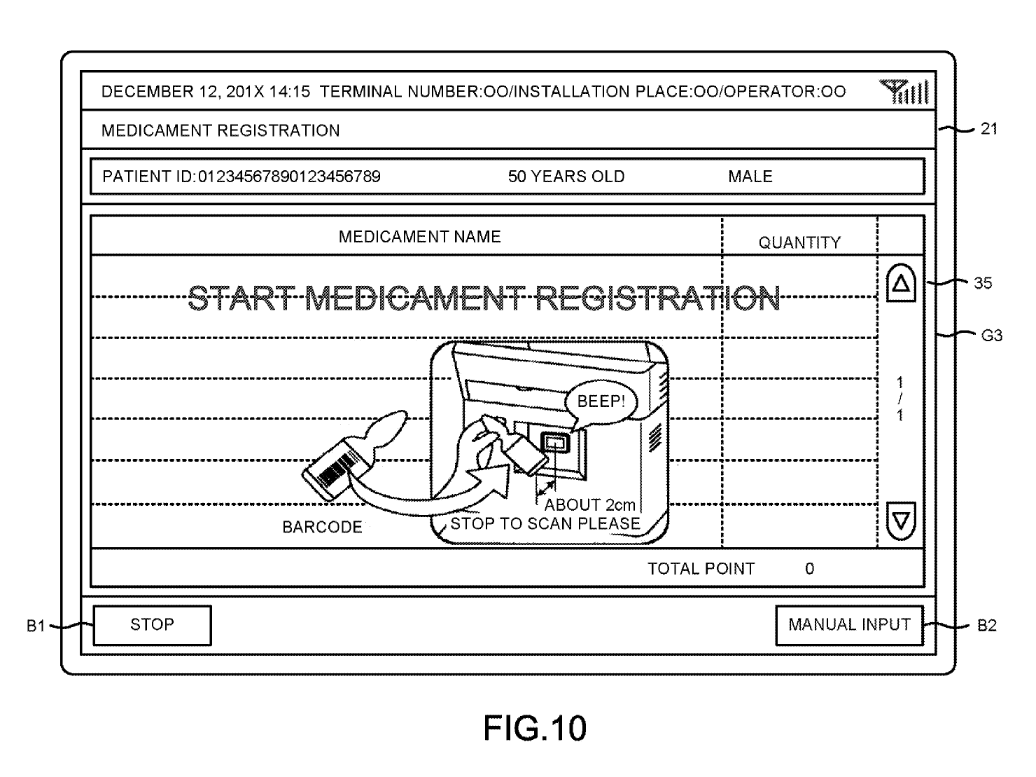

FIG. 10 is a diagram illustrating an example of the medicament registration starting screen G3. A medicament code symbol reading manner is displayed on the medicament registration starting screen G3, as shown in FIG. 10. A “Stop” button B1 and a “Manual Input” button B2 are arranged on the medicament registration starting screen G3. The “Stop” button B1 is used to stop the registration of medicaments. The “Manual Input” button B2 is used to manually input digits put alongside the code symbol of a medicament to register the medicament.

If the “Stop” button B1 is pressed (YES in ACT S6), the MPU 31 of the medicament registration apparatus 20 displays a medicament registration stop screen (not shown) (ACT S7) and terminates the registration of medicaments. On the other hand, if the “Stop” button B1 is not pressed (NO in ACT S6), the MPU 31 of the medicament registration apparatus 20 determines whether or not the “Manual Input” button B2 is pressed (ACT S8).

If the “Manual Input” button B2 is not pressed (NO in ACT S8) but a medicament is held in front of the scanner 22, the MPU 31 of the medicament registration apparatus 20 reads the code symbol of the medicament with the scanner 22.

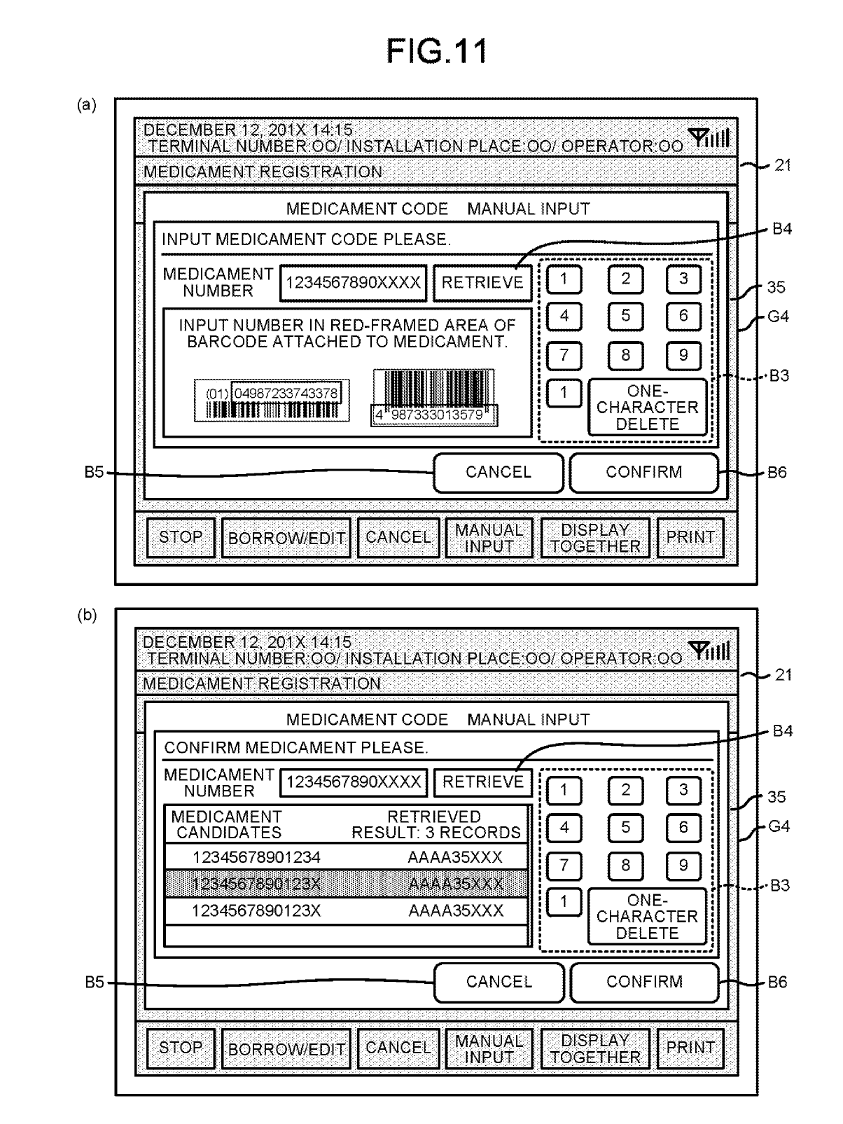

On the other hand, if the “Manual Input” button B2 is pressed (YES in ACT S8), the MPU 31 of the medicament registration apparatus 20 displays a manual input screen G4. FIG. 11 is a diagram illustrating an example of the manual input screen G4. FIG. 11 (a) exemplifies the manual input screen G4 displayed before a retrieval operation is carried out. A guide comment of ‘Input medicament code please’ is displayed on the manual input screen G4 shown in FIG. 11 (a) to request the input of the code information attached to the code symbol. FIG. 11 (b) exemplifies the manual input screen G4 displayed after a retrieval operation is carried out. A guide comment of ‘Confirm medicament please’ is displayed on the manual input screen G4 shown in FIG. 11 (b) to request the confirmation on a medicament from a list of retrieved candidates adapted to the retrieval condition. Further, as shown in FIG. 11, the manual input screen G4 includes numeric buttons B3, a “Retrieve” button B4, a “Cancel” button B5 and a “Confirm” button B6.

The numeric buttons B3 for inputting the code information attached to a code symbol include buttons on the surface of which numerals 0-9 (digits) are displayed and a “One-character Delete” button for deleting one numeral manually input in error. The “Retrieve” button B4 is used for retrieving a medicament having code information coincident with the input numerals (code information of the medicament).

When the “Retrieve” button B4 is pressed, the MPU 31 of the medicament registration apparatus 20 displays the manual input screen G4 after a retrieval operation is carried out on the manual input screen G4.

The “Cancel” button B5 is used for stopping a manual input. The “Confirm” button B6 is used for confirming a retrieved medicament. If the “Cancel” button B5 is pressed (YES in ACT S11), the MPU 31 of the medicament registration apparatus 20 erases the manual input screen G4 and returns to ACT S6. If the “Cancel” button B5 is not pressed (NO in ACT S11) and the “Confirm” button B6 is not pressed either (NO in ACT S12), the MPU 31 of the medicament registration apparatus 20 returns to ACT S10 and maintains the manual input screen G4. If the “Confirm” button B6 is pressed (YES in ACT S12), the MPU 31 of the medicament registration apparatus 20 erases the manual input screen G4 and executes ACT S13.

Next, the MPU 31 of the medicament registration apparatus 20 determines whether or not the medicament information corresponding to the code information of the confirmed medicament is contained in the in-hospital medicament master M3 (ACT S13). If the medicament information is contained in the in-hospital medicament master M3 (YES in ACT S13), the MPU 31 of the medicament registration apparatus 20 registers information of the in-hospital medicament master M3 in the used medicament storage table T (ACT S14).

If the medicament information corresponding to the code information is not contained in the in-hospital medicament master M3 (NO in ACT S13), the MPU 31 of the medicament registration apparatus 20 retrieves the first external medicament master M1 (ACT S15). If the medicament information is contained in the first external medicament master M1 (YES in ACT S15), the MPU 31 of the medicament registration apparatus 20 registers the medicament information in the first external medicament master M1 in the used medicament storage table T (ACT S16).

If the medicament information corresponding to the code information is not contained in the first external medicament master M1 (NO in ACT S15), the MPU 31 of the medicament registration apparatus 20 further retrieves the second external medicament master M2 (ACT S17). If the medicament information is contained in the second external medicament master M2 (YES in ACT S17), the MPU 31 of the medicament registration apparatus 20 registers the medicament information in the second external medicament master M2 in the used medicament storage table T (ACT S18). If the medicament information corresponding to the code information is not contained in the second external medicament master M2 (NO in ACT S17), the MPU 31 of the medicament registration apparatus 20 returns to ACT S6, without registering the medicament, to request a new input.

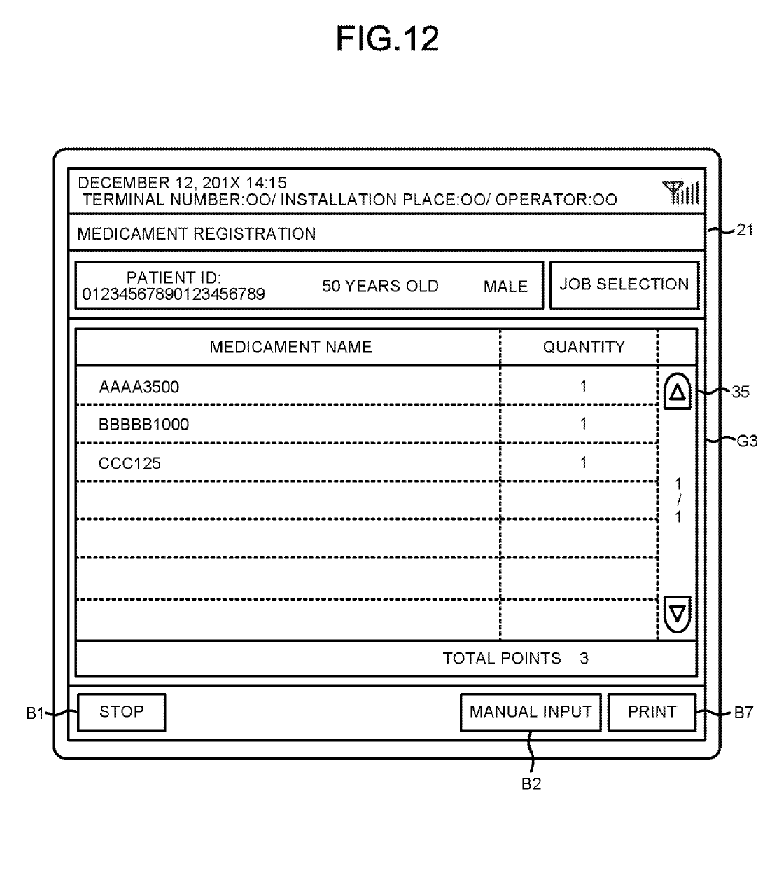

Sequentially, the MPU 31 of the medicament registration apparatus 20 displays the content registered in the used medicament storage table T on a medicament registration screen G5 (ACT S19). FIG. 12 is a diagram illustrating an example of the medicament registration screen G5. As shown in FIG. 12, the medicament registration screen G5 displays a list of the medicaments registered in the used medicament storage table T thereon. If the medicament information corresponding to the code information is contained in the in-hospital medicament master M3, the MPU 31 of the medicament registration apparatus 20 displays the common name for display as a medicament name. If the medicament information corresponding to the code information is contained in the first external medicament master M1 or the second external medicament master M2, the MPU 31 of the medicament registration apparatus 20 displays an official name as a medicament name. Further, the medicament registration screen G5 includes a “Stop” button B1, a “Manual Input” button B2 and a “Print” button B7.

The MPU 31 of the medicament registration apparatus 20 determines whether or not the “Print” button B7 is pressed (ACT S20). If the “Print” button B7 is not pressed (NO in ACT S20), the MPU 31 of the medicament registration apparatus 20 returns to ACT S6 to request a new input.

On the other hand, if the “Print” button B7 is pressed (YES in ACT S20), the MPU 31 of the medicament registration apparatus 20 prints the content registered in the used medicament storage table T on a used medicament slip D (ACT S21).

As stated above, according to the present embodiment, the first external medicament master M1, the second external medicament master M2 and the in-hospital medicament master M3 in which a medicament information output form is stored are provided. Moreover, the in-hospital medicament master M3 contains medicament information including the determined output form such as the classification, the common name and the display order of a medicament and the like. The MPU 31 of the medicament registration apparatus 20 can easily customize the output form of a slip by displaying or printing the slip according to the determined output form in the in-hospital medicament master M3.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

Further, in the embodiment above, a medicament master containing medicament information is not displayed in a case in which a registered medicament is displayed on the display 35. However, a medicament master containing medicament information may be displayed. For example, a medicament master may be displayed in brackets beside a medicament name. Alternatively, a dedicated column may be set for the medicament master. A medicament master may be added with mark and the like to be distinguishable. Alternatively, a medicament master may be distinguished by being displayed with color different from others.

Further, in the embodiment above, in an apparatus other than the external storage device 34. For example, the medicament masters may also be arranged in the pharmacy server 19. In this case, the medicament registration apparatus 20 communicates with the pharmacy server 19 via the communication interface 38 in an environment covered by the communication network 17.

In the embodiment above, code information is read from the code symbol such as a barcode or a two-dimensional code attached to a medicament. However, code information may be acquired from a storage medium, for example, containing code information other than the code symbol. For example, code information may be read from an RFID. In this case, an RFID reader is newly provided.

Further, in the embodiment above, a patient ID is input, as described in the flowchart. However, a patient ID may not be input depending on a case. Thus, a patient can be quickly treated in case of emergency.

Further, in the embodiment above, the programs executed by each device are pre-installed in the storage medium (ROM or storage section) of the device, however, the present invention is not limited to this, the programs may be stored in a computer-readable recording medium such as CD-ROM, flexible disc (FD), CD-R, DVD (Digital Versatile Disk) in an installable or executable file. Moreover, the storage medium, which is not limited to a medium independent from a computer or an assembled system, may include a storage medium which downloads the programs that are transmitted over a LAN or the Internet and the like and then stored or temporarily stored.

In addition, the programs executed by each device described in the embodiment above may be stored in a computer connected with a network such as the Internet and the like so as to be provided after being downloaded from the network or provided or distributed by a network such as the Internet and the like.

What is claimed is:

1. A medicament registration apparatus, comprising:
a storage section configured to store a first medicament master in which first medicament information relating to each medicament is held and a second medicament master in which second medicament information including determined output form of each medicament is held;
a recognition module configured to recognize a medicament of a reading target; and
an output control module configured to output the first medicament information corresponding to the medicament recognized by the recognition module in accordance with the determined output form in the second medicament information.

2. The medicament registration apparatus according to claim 1, wherein
the second medicament master contains classification information for classifying the medicament as the second medicament information; and
the output control module outputs the first medicament information in the form of groups according to classification information.

3. The medicament registration apparatus according to claim 1, wherein
the second medicament master contains replacement information for replacing the medicament name contained in the first medicament information with another medicament name as the second medicament information; and
the output control module outputs another medicament name to which the medicament name contained in the first medicament information is replaced according to the replacement information.

4. The medicament registration apparatus according to claim 3, wherein
the output control module outputs the name of the medicament master, in which the first or second medicament information that is used to output the medicament name is stored, in association with the medicament name.

5. The medicament registration apparatus according to claim 1, wherein
the second medicament master contains order information for determining the output order of the first medicament information as the second medicament information; and
the output control module outputs the first medicament information rearranged in the order thereof according to the order information.

6. A method for registering a medicament by a medicament registration apparatus having a storage section which stores a first medicament master in which first medicament information relating to each medicament is held and a second medicament master in which second medicament information including determined output form of each medicament is held, including:
recognizing a medicament; and
outputting the first medicament information corresponding to the recognized medicament according to the determined output form in the second medicament information.
